(19) United States
(12) Patent Application Publication
(10) Pub. No.: US 2010/0017336 A1
(43) Pub. Date: Jan. 21, 2010

(54) ACCOUNT DETERMINATION USING GOVERNMENT-ISSUED IDENTIFICATION DEVICE

(76) Inventor: Clifford J. Whyte, Marietta, GA (US)

Correspondence Address: BUCKLEY, MASCHOFF & TALWALKAR, LLC;GENERAL ELECTRIC COMPANY, 50 LOCUST AVENUE, NEW CANAAN, CT, 06840, US

(21) Appl. No.: 12/175,055

(22) Filed: Jul. 17, 2008

(51) Int. Cl. G06Q 20/00

(52) U.S. Cl. 705/76

(57) ABSTRACT

A system may include reading of information from a government-issued identification device and determination of a commercial account number based on the information. A payment may be processed using the commercial account number. In some aspects, the information identifies a holder of the government-issued identification device and the commercial account number is a temporary account number associated with the holder. Determination of the commercial account number may include determination of a plurality of commercial account numbers based on the information, and determination of the commercial account number from the plurality of commercial account numbers.

### FIELD

Some embodiments relate to electronic commerce systems. More specifically, some embodiments concern using government-issued identification devices within electronic transactions.

### BACKGROUND

Modern electronic networks facilitate a variety of financial transactions between businesses and consumers. In one common example, electronic credit card terminals provide virtually worldwide access to consumer credit accounts. Electronic networks may also provide access to other types of accounts (e.g., frequent buyer accounts, rewards accounts, etc.) which enrich interactions between businesses and consumers.

A consumer may be associated with several credit card accounts and other business-related accounts. In order to access any of these accounts via an electronic network or otherwise, the consumer is required to provide an associated account number. The consumer therefore carries each account number on her person in the form of a machine-readable card, key fob, or other device. A reading device reads an account number from one or more of such devices during a transaction.

It is desirable to reduce a need for a consumer to carry a device corresponding to each of the consumer's accounts. Moreover, it is desirable to reduce the cost and time required to issue such devices to consumers.

### BRIEF DESCRIPTION OF THE DRAWINGS

FIG. 1 is a diagram of a network topology according to some embodiments.

FIG. 2 is a flow diagram of a process according to some embodiments.

FIG. 3 is a block diagram of a reader device according to some embodiments.

FIG. 4 is a tabular representation of a portion of a database according to some embodiments.

### SUMMARY

Some aspects relate to a system, method, apparatus, computer-readable medium, and means to encode information decoded by a government-issued identification device and to determine a commercial account number based on the information. In some aspects, a payment may be processed using the commercial account number. In some aspects, the information indicates a holder of the government-issued identification device and the commercial account number is a temporary account number associated with the holder. Determination of the commercial account number may include determination of a plurality of commercial account numbers based on the information, and determination of the commercial account number from the plurality of commercial account numbers.

In some aspects, determination of the commercial account number includes formatting the information into a common format, transmitting the formatted information to a card transaction processor, and receiving the commercial account number from the card transaction processor.

The claims are not limited to the disclosed embodiments, however, as those in the art can readily adapt the description herein to create other embodiments and applications.

### DETAILED DESCRIPTION

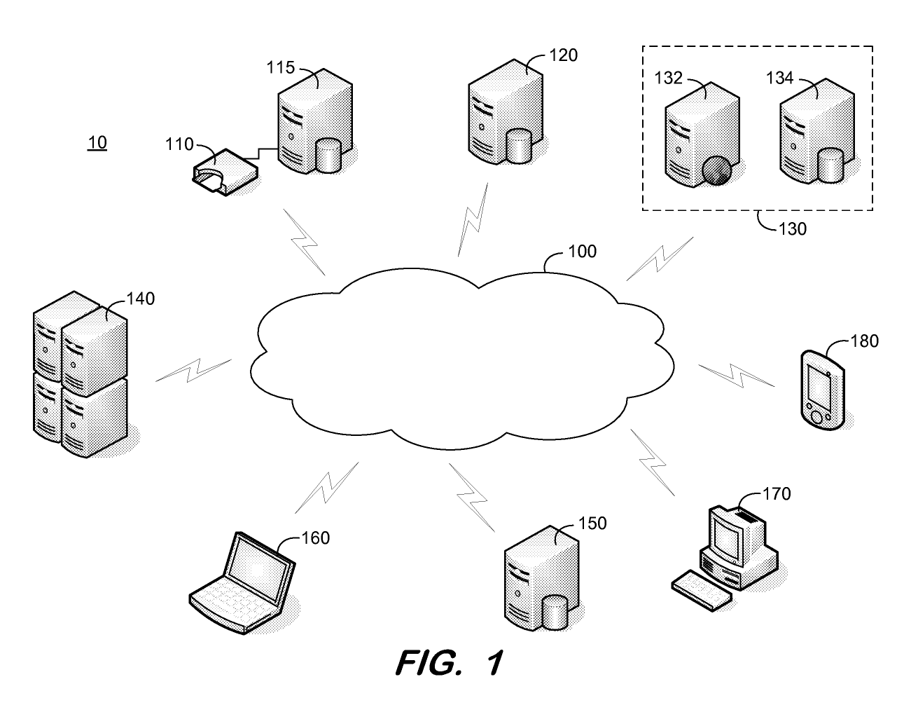

FIG. 1 is a block diagram of system 10 according to some embodiments. Each device of system 10 is capable of communication with network 100, which may comprise the Internet and/or any number of other public and/or private networks. Two or more of devices of system 10 may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

System 10 includes reading device 110 coupled to processing device 115. In some embodiments, reading device 110 and processing device 115 comprise components of a point-of-sale (POS) terminal as is or becomes known.

Reading device 110 may comprise hardware and software suitable to decode information encoded by one or more various types of government-issued identification devices. Non-exhaustive examples of such identification devices include driver's licenses, passports and state IDs. An identification device according to some embodiments may encode information according to any suitable currently- or hereafter-known systems. For example, an identification device may encode information using one or more of: a barcode; a magnetic stripe (2, 3, or n tracks); a hologram; an image (e.g., a fingerprint); and any other encoding medium.

The information may be encoded by the identification device based on its encoding medium and an encoding protocol. The decoded information may, in addition, be formatted according to any suitable formatting protocol. For example, the information may be decoded based on the encoding protocol to produce a series of numbers, but the meaning of the numbers may depend entirely on the formatting protocol. Reading device 110 and/or processing device 115 may further process the decoded information based on the formatting protocol according to some embodiments. In some embodiments, the formatting protocol may be an element of the encoding protocol.

The decoded information may include information identifying a holder of the government-issued identification device. Identifying information may include a social security number, a name, an address, and/or an ID number (e.g., a driver's license number).

Processing device 115 may, in some embodiments, determine a commercial account number based on the information decoded by reading device 110. The commercial account number may represent, for example, a credit card account, a preferred buyer account, or a rewards account. Processing device 115 may determine the commercial account number based on an internal database, by transmitting information to a remote device, and/or by any other means.

In some embodiments, processing device 115 determines two or more commercial account numbers associated with the decoded information, and selects one commercial account number from the two or more commercial account numbers. Processing device 115 may then use the selected commercial account number to process a payment in some embodiments. Processing device 115 may also provide other types of payment processing, item price and information lookup, order placement, and inventory tracking.

In some embodiments, processing device 115 transmits the decoded information, with or without some prior processing, to processing system 120. Processing system 120 may comprise a system of a credit card transaction processor, such as but not limited to First Data®. Processing system 120 may provide information to determine a commercial account number based on the decoded information and/or to process a payment using the number according to some embodiments.

Network 130 of system 10 may support online commerce. In particular, Web server 132 may support HyperText Transfer Protocol (HTTP) communication with Web clients. Such communication may provide a website for providing product information, responding to customer inquiries, and editing customer account information. For example, a customer may access Web server 132 using a Web client to associate his driver's license number with a commercial account number provided by the proprietor of network 130.

Web server 132 may query data server 134 for information required to provide such a website. Data server 134 may maintain associations between a customer's government-issued identification device and one or more of the customer's commercial account numbers. Data server 134 may also support online transaction processing (OLTP) and provide various reporting features that are or become known. Network 130 may also comprise devices in addition to those illustrated.

A credit issuer may operate application servers 140 in some embodiments. The credit issuer may underwrite a credit card product that is offered to customers. Application servers 140 may maintain an association between an account number of an issued credit card and information identifying a holder of a government-issued identification device (e.g., a driver's license number). Application servers 140 may execute a suite of business applications to provide these and other business functions to the credit issuer.

Server 150 may store and provide commercial account numbers associated with one or more customers. For example, server 150 may store and provide, for each of several individuals, a frequent buyer account number associated with information identifying the individual. The frequent buyer account number may be associated with a retail store operating server 140.

Client devices 160 through 180 comprise a laptop computer, a desktop computer, and a personal digital assistant, respectively. Devices 160 through 180 may be operated to associate information encoded in a government-issued identification device with one or more commercial account numbers. In some embodiments, devices 160 through 180 execute a client application such as a Web browser or a Java applet to establish such associations within a database such as that provided by server 120. Server 120, in turn, provides server functionality to communicate with and receive such associations with a client application. Client devices 160 through 180 may comprise any suitable devices, and are not limited to those illustrated in FIG. 1.

Each of elements 110 through 180 may include any number of disparate hardware and/or software elements, some of which may be located remotely from one another. Functions attributed to one element may be performed by one or more other elements in some embodiments. The elements of system 10 may communicate with one another (and with other non-illustrated elements) over any suitable communication media and protocols that are or become known.

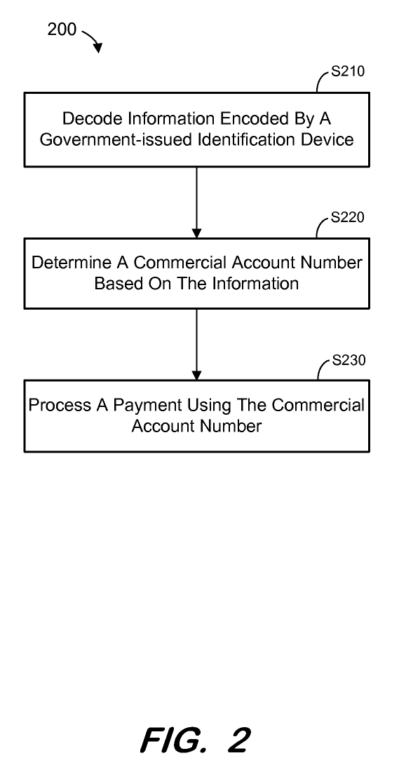

FIG. 2 is a flow diagram of process 200 according to some embodiments. Elements of system 10 may execute process 200 in some embodiments.

Process 200 and all other processes mentioned herein may be embodied in processor-executable program code read from one or more of a computer-readable medium, such as a floppy disk, a CD-ROM, a DVD-ROM, a Zip™ disk, a magnetic tape, and a signal encoding the process, and then stored in a compressed, uncompiled and/or encrypted format. In some embodiments, hardwired circuitry may be used in place of, or in combination with, program code for implementation of processes according to some embodiments. Embodiments are therefore not limited to any specific combination of hardware and software.

Initially, at S210, information encoded by a government-issued identification device is decoded. A card reader decodes a magnetic stripe on a driver's license in some embodiments of S210. More particularly, information encoded by the magnetic stripe is decoded to generate an alphanumeric sequence. The alphanumeric sequence may comprise a driver's license number in some embodiments.

The government-issued identification device may comprise a state ID or other device. Moreover, the identification device may encode information using one or more of: a barcode; a 2, 3, or n track magnetic stripe; a hologram; an image (e.g., a fingerprint); and any other encoding medium. The encoding protocol or system is known to the elements that are to decode the information. The decoded information, in turn, may include information identifying a holder of the government-issued identification device. Such identifying information may include a social security number, a name, an address, and/or an ID number.

According to some embodiments, S210 is performed at a POS terminal at a retail store. For example, a customer may approach the POS terminal with items for purchase. The POS terminal may be operated by a cashier or may comprise a self-serve kiosk. After the total cost of the items is determined, the customer is prompted for payment. The customer, in response, presents a government-issued identification device to a device reader. The device reader then decodes information encoded by the identification device at S210.

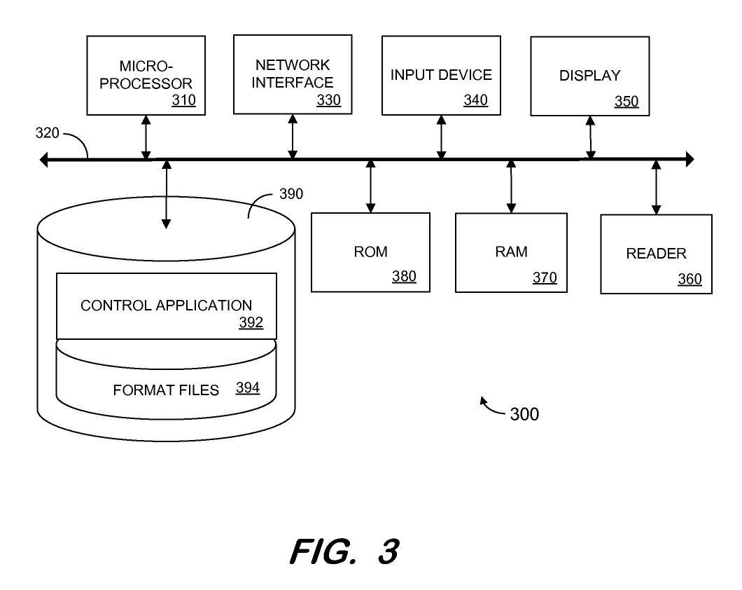

FIG. 3 is a block diagram of an internal architecture of reading device 300 according to some embodiments. Reading device 300 may comprise an implementation of reading device 110 of FIG. 1, but embodiments are not limited thereto. Reading device 300 may execute S210 of process 200 in some embodiments.

Reading device 300 includes microprocessor 310 in communication with communication bus 320. Microprocessor 310 may comprise any microprocessor to execute processor-executable program code to control the elements of reading device 300. Microprocessor may comprise a dedicated controller, an application-specific integrated circuit, and/or any other logic device.

Also in communication with communication bus 320 is network interface 330. Network interface 330 is used to transmit data to and to receive data from devices external to reading device 300 such as devices 115 through 180 of system 10. Network interface 330 is therefore preferably configured with hardware suitable to physically interface with desired external devices and/or network connections. For example, network interface 330 may comprise an Ethernet connection to a local area network through which reading device 300 may receive and transmit information over the Web.

Input device 340 and display 350 are also in communication with communication bus 320. Any known input device may comprise input device 340, including a keypad, mouse, touch pad, voice-recognition system, or any combination of these devices. Of course, information may also be input to reading device 300 via network interface 330. Some embodiments lack input device 340.

Display 350 may be an integral or separate display using light-emitting diode, vacuum-fluorescent, liquid-crystal diode, plasma, cathode ray tube or other display technology. Display 350 may present graphics and text in response to commands issued by microprocessor 310. For example, display 350 may display instructions for submitting an identification device for decoding, price information, authorization data, and/or the decoded information mentioned above.

Reader 360 may comprise any hardware required to detect and decode information encoded by a government-issued identification device. Such hardware may include but is not limited to a barcode scanners or a magnetic stripe reader. Embodiments are contemplated for use in conjunction with any readable encoding media that are or become known.

RAM 370 is connected to communication bus 320 to provide microprocessor 310 with fast data storage and retrieval. In this regard, processor-executable program code executed by microprocessor 310 is typically stored temporarily in RAM 370 and executed therefrom by microprocessor 310. ROM 380, in contrast, provides storage from which data can be retrieved but to which data cannot be stored. Accordingly, ROM 380 may be used to store invariant process steps and other data, such as basic input/output instructions and data used during boot-up of reading device 300 or to control reader 360. One or both of RAM 370 and ROM 380 may communicate directly with microprocessor 310 instead of over communication bus 320.

Data storage device 390 stores, among other data, processor-executable program code of control application 392. Reading device 300 may execute control application 392 to provide the functions attributed herein to reading device 300. For example, control application 392 may include program code executable to operate reader 360 to sense the encoded information on/in a government-issued identification device and to decode the information. In some embodiments, data storage device 390 comprises a hard disk, a removable storage medium (e.g., flash drive, memory card), or an electronically programmable read-only memory.

Format files 394 may provide information usable to determine the meaning of the decoded information. Format files 394 may comprise details of various formats with which the decoded information may comply. Control application 392 may thereby compare decoded information against format files 394 to convert the decoded information to delimited data.

Returning to process 200, a commercial account number is determined based on the decoded information at S220. The commercial account number may represent, for example, a credit card account, a preferred buyer account, or a rewards account. In some embodiments, the commercial account number is determined by processing device 115 of system 10.

Processing device 115 may determine the commercial account number based on an internally-stored database. In this regard, processing device 115 may compare the decoded information against a database which associates such information with commercial account numbers. Processing device 115 may re-format or otherwise extract specific information from the decoded information prior to querying such a database. For example, if not already done so by reading device 110, processing device may parse the decoded information based on a determined information format to determine specific data values (e.g., a driver's license number).

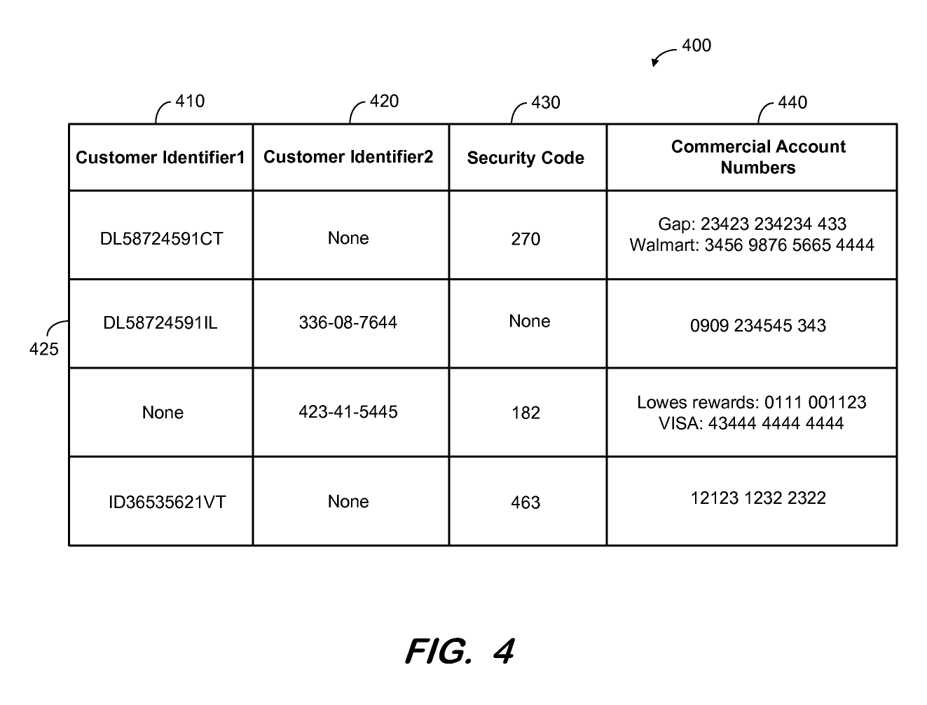

FIG. 4 is a tabular representation of a portion of database 400 according to some embodiments. Database 400 may be stored by processing device 115 and/or in any of devices 120 through 150 of system 10. For example, some of the illustrated associations may be stored in one data server while some of the associations may be stored in other data servers.

Fields 410 and 420 of database 400 specify customer identifiers. In some embodiments of S220, decoded information from an identification device is compared against the values of fields 410 and 420. For example, a match may be detected in row 425 if the decoded information is “DL5872459IL”. A match may also be detected in row 425 if the decoded information is “336-08-7644”. In some embodiments, the decoded information must include values of fields 410 and 420 for a match to be detected.

If a match is detected, other decoded information (e.g., representing a last three digits of a holder's birthdate) may be compared with a value of security code field 430 that is associated with the matching customer identifier. If the values are equal, one or more values from an associated commercial account number field 440 are determined. Some embodiments do not require security code field 430.

The information of database 400 may be associated therein in any suitable manner. A credit card issuer may simply map an applicant's driver's license number to a new credit card number when issuing the credit card. The mapping may be located at the issuer's servers.

According to some embodiments, a credit card issuer provides a Website through which a cardholder may associate her driver's license number (or other government-issued identification) with her credit card number. The cardholder may provide other identification information such as that shown in field 420 and select whether this information is to be used in lieu of or in addition to her driver's license number to determine associated commercial account numbers.

Such a Website may also allow the cardholder to associate other commercial account numbers with the driver's license number. This feature may allow the cardholder to use a single government-issued identification device instead of two or more separate cards that would otherwise be required to access the two or more commercial accounts.

Returning to process 200, a payment is processed using the commercial account number at S230. The account number may be determined at S220 and the payment may be processed at S230 by a same system, such as processing system 120, by different systems, and/or by several systems working in combination. Any systems to process a payment using a commercial account number may be used at S230.

In some embodiments, the commercial account number is not associated with an account that can be used to process a payment. For example, the number may specify a rewards account, in which case S230 may comprise determining a number of rewards points associated with the account. S230 may also or alternatively comprise adding or deducting a suitable number of points to or from the rewards account based on purchasing activity.

Generally, some embodiments may allow a government-issued identification device to take the place of one or more devices (cards, fobs, etc.) for accessing commercial account numbers. Such features may increase convenience for customers, reduce plastic and printing costs, and/or reduce fraud due to security measures typically employed by government-issued identification devices.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize other embodiments may be practiced with modifications and alterations limited only by the claims.

What is claimed is:

1. A method comprising:
decoding information encoded by a government-issued identification device; and
determining a commercial account number based on the information.

2. A method according to claim 1, further comprising:
processing a payment using the commercial account number.

3. A method according to claim 2, wherein the information identifies a holder of the government-issued identification device, and
wherein the commercial account number is a temporary account number associated with the holder.

4. A method according to claim 1, wherein determining the commercial account number comprises:
determining a plurality of commercial account numbers based on the information; and
determining the commercial account number from the plurality of commercial account numbers.

5. A method according to claim 1, further comprising:
determining a number of membership points associated with the commercial account number.

6. A method according to claim 1, wherein determining the commercial account number comprises:
formatting the information into a common format;
transmitting the formatted information to a card transaction processor; and
receiving the commercial account number from the card transaction processor.

7. A method according to claim 1, wherein the commercial account number comprises a frequent buyer account number, the method further comprising:
crediting a number of account points to the frequent buyer account.

8. A computer-readable medium storing processor-executable program code, the program code comprising:
code to decode information encoded by a government-issued identification device; and
code to determine a commercial account number based on the information.

9. A medium according to claim 8, the program code further comprising:
code to process a payment using the commercial account number.

10. A medium according to claim 9, wherein the information identifies a holder of the government-issued identification device, and
wherein the commercial account number is a temporary account number associated with the holder.

11. A medium according to claim 8, wherein the code to determine the commercial account number comprises:
code to determine a plurality of commercial account numbers based on the information; and
code to determine the commercial account number from the plurality of commercial account numbers.

12. A medium according to claim 8, the program code further comprising:
code to determine a number of membership points associated with the commercial account number.

13. A medium according to claim 8, wherein the code to determine the commercial account number comprises:
code to format the information into a common format;
code to transmit the formatted information to a card transaction processor; and
code to receive the commercial account number from the card transaction processor.

14. A medium according to claim 8, wherein the commercial account number comprises a frequent buyer account number, the program code further comprising:
code to credit a number of account points to the frequent buyer account.

15. An apparatus comprising:
a reader device to decode information encoded by a government-issued identification device; and
a processing device to determine a commercial account number based on the information.

16. An apparatus according to claim 15, the processing device to process a payment using the commercial account number.

17. An apparatus according to claim 16, wherein the information identifies a holder of the government-issued identification device, and
wherein the commercial account number is a temporary account number associated with the holder.

18. An apparatus according to claim 15, wherein the processing device is to determine the commercial account number by:
determining a plurality of commercial account numbers based on the information; and
determining the commercial account number from the plurality of commercial account numbers.

19. An apparatus according to claim 15, the processing device to determine a number of membership points associated with the commercial account number.

20. An apparatus according to claim 15, wherein the processing device is to determine the commercial account number by:
formatting the information into a common format;
transmitting the formatted information to a card transaction processor; and
receiving the commercial account number from the card transaction processor.

21. An apparatus according to claim 15, wherein the commercial account number comprises a frequent buyer account number, and the processing device is to credit a number of account points to the frequent buyer account.
